(19) United States
(12) Patent Application Publication
(10) Pub. No.: US 2019/0048809 A1
(43) Pub. Date: Feb. 14, 2019

(54) ENGINE PROFILE MANAGEMENT

(71) Applicant: Intel IP Corporation, Santa Clara, CA (US)

(72) Inventors: Maik Sven FOX, Karlsruhe (DE); Roman SCHICK, Krailling (DE); Daniel POHL, Puchheim (DE)

(21) Appl. No.: 16/106,012

(22) Filed: Aug. 21, 2018

(51) Int. Cl. F02D 35/00; G01C 21/26

(52) U.S. Cl. CPC F02D 35/0015; F02D 2200/701; G01C 21/26

(57) ABSTRACT

Herein is disclosed a vehicle engine operation profile selection device comprising one or more sensors, configured to detect sensor data; and one or more processors, configured to select an engine operation profile from a plurality of engine operation profiles based on the sensor data; and operate an engine according to the selected engine operation profile.

### TECHNICAL FIELD

Various aspects of the disclosure relate generally to the selection of engine profiles based at least on sensor input.

### BACKGROUND

Engines, such as electric engines and combustions engines, may be operated according to a variety of profiles based on a desired emission result. Moreover, hybrid vehicles may be operated using an electric engine, a combustion engine, or a combination of the electric engine and the combustion engine. The ability or desire to operate a combustion engine according to any one or more of a plurality of profiles, in contrast to operating an electric engine may be influenced by exterior factors, such as emissions standards, air quality, or environmental regulations.

### SUMMARY

Herein is disclosed a vehicle engine operation profile selection device comprising one or more sensors, configured to detect sensor data; and one or more processors, configured to select an engine operation profile from a plurality of engine operation profiles based on the sensor data; and operate an engine according to the selected engine operation profile.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 depicts a procedure for managing an engine profile;

FIG. 2 depicts an identification of an applicable emission regulation based on geographic information;

FIG. 3 depicts an identification of an applicable emission regulation based on ageographic information;

FIG. 4 depicts image data analysis to detect an emission regulation sign or marking;

FIG. 5 depicts an environmental analysis to select an emission profile;

FIG. 6 depicts engine profiles for operation of a hybrid vehicle;

FIG. 7 depicts engine profiles for operation of an engine emission;

FIG. 8 depicts a vehicle engine operation profile selection device;

FIG. 9 depicts a method for selecting a vehicle engine operation profile.

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration.” Any aspect of the disclosure described herein as “exemplary” is not necessarily to be construed as preferred or advantageous over other aspects of the disclosure.

Throughout the drawings, it should be noted that like reference numbers are used to depict the same or similar elements, features, and structures.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

Vehicles may be called upon to operate according to various emission profiles. According to one aspect of the disclosure, a combustion engine may be operated according to any of a plurality of engine profiles, the engine profiles being designed to create a desired emission output, such as altering an output of carbon dioxide, nitrogen oxide, particulate matter, etc. Where selection of an engine profile is desired, reliance on user selection may not reach satisfactory efficiency and may further be a distraction from safe vehicle operation.

A combustion engine profile may be selected according to one or more regulations or statutes. Vehicles may be built with a certain exhaust gas emission profile, which corresponds to regulations in existence at the time of manufacture. However, such regulations tend to be in flux and may occasionally change to meet various goals, such as environmental emission targets. Although subsequently manufactured vehicles may be designed and manufactured according to the new regulations, a change in a regulation or statute may have no effect on previously-manufactured vehicles. Because of the changing nature of such regulations, it may be desirable to maintain a flexibility of engine emissions profiles, such that operation of combustion engines may change to accommodate changing regulations.

In addition to changing over time, such environmental regulations may be region specific. For example, in Germany, environmental regulations may prevent the operation of vehicles with specific emission standards within certain regions or cities. On the micro-level, such regulations may even prohibit operation of vehicles with certain emission standards or emission products from operating on specific streets within a city or region, even if the vehicle may otherwise lawfully operate in other areas of the city or region. In Germany, it is generally possible to ban vehicles based on an emissions classification, and it may be possible to ban vehicles with an emissions classification that is considered the state of the art in emissions control. Similarly, in the United States of America, and in addition to the federal emissions standards, individual states or potentially municipalities may create stricter standards that would prevent the operation of certain vehicles within said states or municipalities, based on the vehicle's combustion engine output.

Given the location-specific nature of emission standards, and the manner in which such standards are subject to change, it may be desired to operate a vehicle according to one of a plurality of combustion engine operation profiles, and to create a mechanism to change the profile as needed. It may be desired to obtain current information about emission standards and/or environmental conditions and to implement an algorithm to select a suitable emission profile from a plurality of emission profiles based on the obtained information.

Although current technology may not permit emission-free operation of combustion engines, various trade-offs can be implemented to alter the resulting emission components. For example, the plurality of emission profiles may offer various emission compromises, such as compromises to achieve decreased fuel consumption, decreased gas emission, decreased particulate matter emission, increased or decreased power output, increased or decreased torque, or increased or decreased use of additives (such as urea treatment for exhaust), etc. These profiles may be selected based on, for example, one or more factors in the vehicle's vicinity. This solution may provide the car and its driver with uncompromised mobility while allowing for dynamic compromises on engine performance to meet emission targets and/or comply with emission regulations. This may further result in time-savings, since dynamic emission profile selection may provide the vehicle with access to streets or regions which may otherwise be prohibited, thereby potentially increasing route availability to reach a destination.

According to one aspect of the disclosure, dynamic selection of engine profiles may utilize information about a vehicle's location, which is then cross-referenced with environmental information corresponding to the vehicle's location. This method requires at least one sensor to detect a location, and a sensor to receive the environmental information.

The location information may be obtained using an known technology to obtain a location, including, but not limited to, a positioning system such as the Global Position System (“GPS”), Galileo, Beidou Navigation System, or Indian Regional Navigation System; a wireless telecommunication positioning system; Long Term Evolution Positioning Protocol; 5G Positioning Protocol; Assisted-GPS; Observed Time Difference of Arrival positioning system; odometry; or otherwise. Using any of these positioning systems, the vehicle may be able to determine with sufficient accuracy an absolute position of the vehicle. The absolute position may, for example, correspond to a latitude and a longitude, a vector, a distance and/or direction from a fixed point, or any other method of positional representation.

The location information may be compared to, or cross-referenced with, a geographic information, which may correspond to a plurality of regions, such as a plurality of states, cities, streets, or otherwise. The geographic information may contain an environmental information, such as an emission restriction or environmental quality. Where the environmental information contains an emission restriction, it may contain a law, ordinance, regulation, or any other restriction pertaining to operation of a combustion engine. The environmental information may alternatively be a quality of the environment, such as a measure of a gas (for example, carbon dioxide, a nitrogen oxide, etc.), particulate matter, smog, or otherwise. The geographic information may be formatted as a map, a list, a table, a database, or any other method of managing said data.

The geographic data may be commercially available data. Many regions or countries publish their own geographic data, such as map data, which shows environmental information relative to a geographic region. For example, a Real-Time Air Quality Index (“AQI”), which shows measurements of air quality in most or all areas of the world, is available through multiple websites. A map known as “Current Concentrations of Air Pollutants in Germany” is published by the German Office of the Environment (Umweltbundesamt). The United States Environmental Protection Agency publishes an Interactive Map of Air Quality Monitors. Although these specific references are mentioned herein, the geographic information and environmental information is not limited to these examples, and any source of geographic information or environmental information may be used.

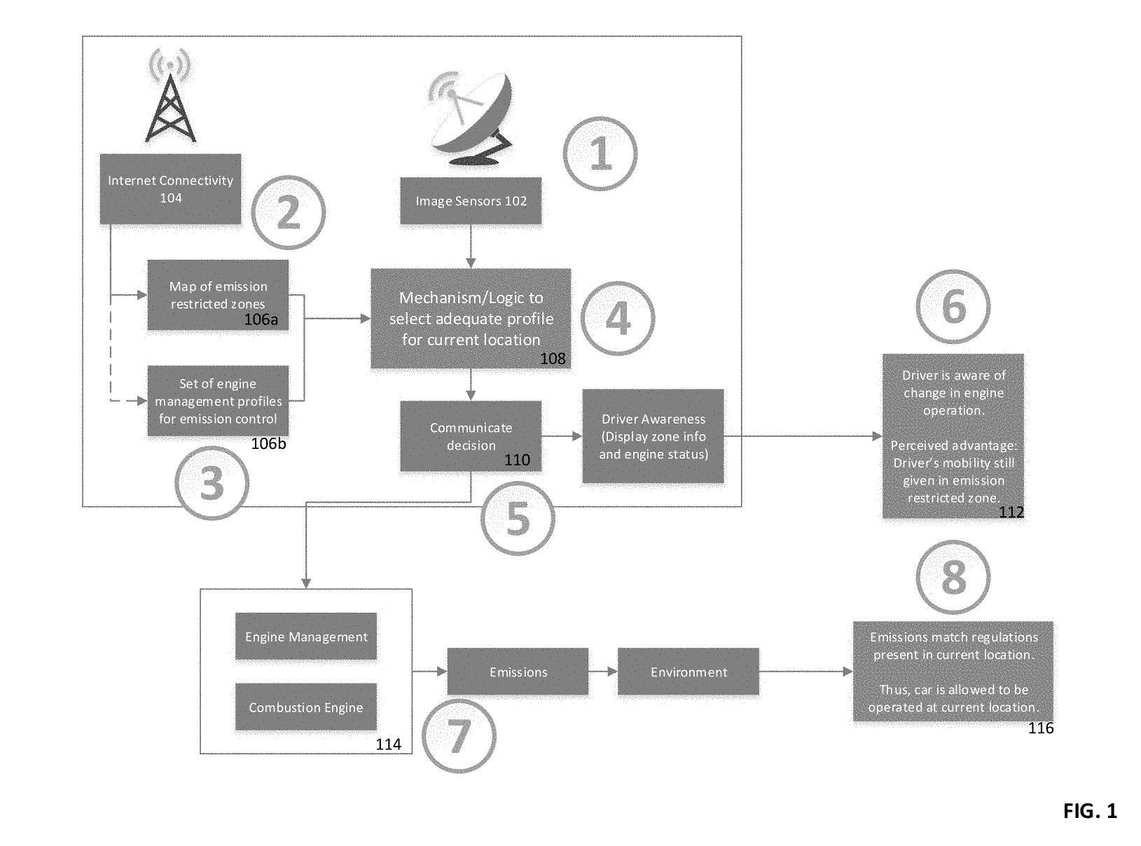

FIG. 1 shows procedure of combustion engine profile management according to an aspect of the disclosure. According to this procedure, the vehicle uses one or more location sensors to determine a vehicle location 102. As described herein, this may be achieved via Global Positioning System or another means of determining a location. The vehicle may wirelessly connect to an external source 104 to receive or update geographic information or emission information 106a. Alternatively or additionally, the vehicle may wirelessly connect to an external source 104 to receive updated engine profiles 106b. The vehicle is equipped with one or more processors 108 which are configured to determine from the location, the geographic information, and the environmental information an emission regulation that corresponds to the vehicle's location, and to select an engine profile based on the determined emission regulation that corresponds to the vehicle's location. The vehicle may be configured to communicate the selected engine profile to a driver or passenger of the vehicle 110, which may be achieved by, for example, displaying or announcing the decision. By communicating the selected engine profile to the driver or passenger, the driver or passenger becomes aware of the decision and any change in operation. Furthermore, notifying the driver or passenger 112 may permit the driver or passenger to cause the vehicle to utilize a zone which may have been previously unavailable to the vehicle due to the vehicle's emission and an emission restriction. The vehicle employs the selected emission profile, which alters the operation of the combustion engine 114 to achieve a desired emission result, such as a decrease in one or more gasses, a decrease in particulate matter, a decrease in fuel consumption, or otherwise. By implementing the selected engine profile, the vehicle emissions are able to meet the requirements of the emission restrictions that are relevant to the vehicle's location 116.

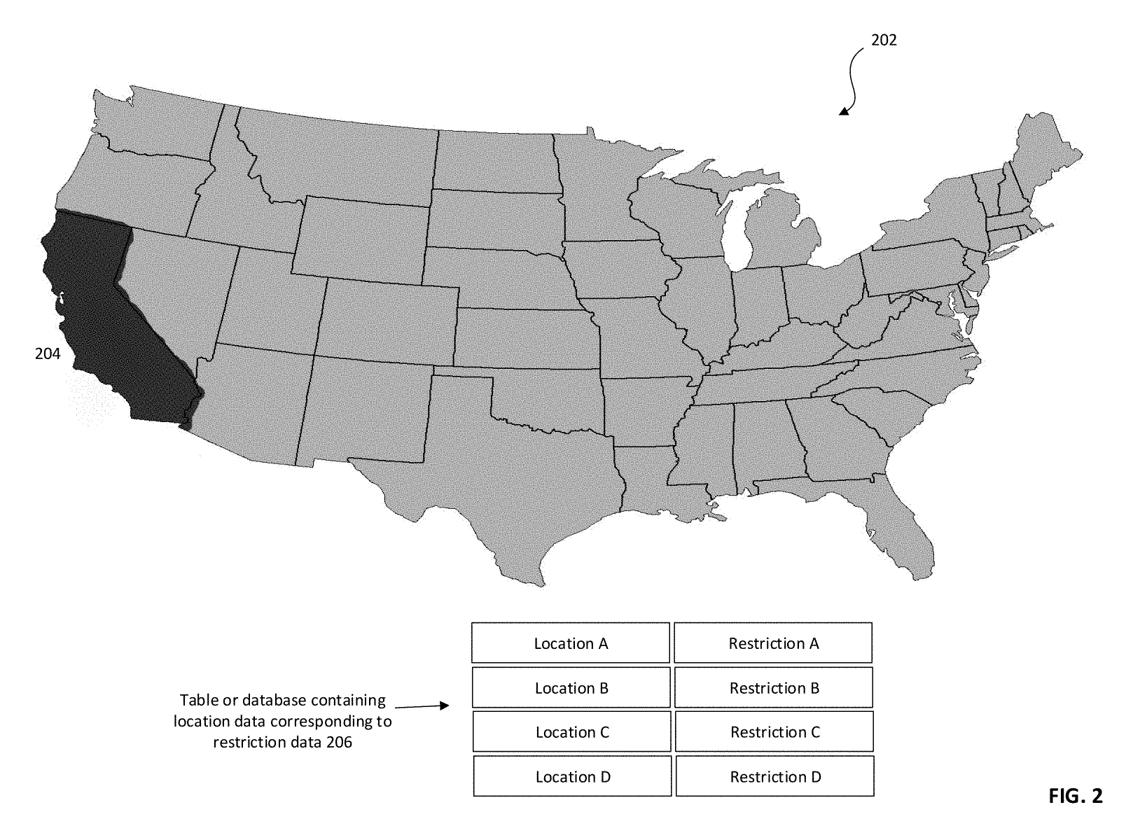

FIG. 2 depicts a region with an increased emission restriction. Whether a continent, a country, a state, a city, a neighborhood, a street, or otherwise, a region may be selected as having a more stringent environmental regulation than a neighboring region. For demonstrative purposes, the state of California is selected. Although certain emissions standards may apply to each state within the United States of America, states may be free to impose a stricter emissions standard than those which are nationally required. FIG. 2 depicts a map of the United States 202, which is subject to a first plurality of emissions standards. Within the United States is the State of California 204, which has imposed a second more stringent set of emissions standards. The region of the first set of standards 202 corresponds to location information, such that for any vehicle location, the vehicle location may be compared to the location information corresponding to the region of the first plurality of standards 202 to determine whether the vehicle is within or outside of the region corresponding to the first plurality of standards. The region of the second set of standards 204 also corresponds to location information, such that for any vehicle location, the vehicle location may be compared to the location information corresponding to the region of the second set of standards 204 to determine whether the vehicle is within or outside of the region corresponding to the second plurality of standards. The corresponding location information may be stored in a table or database 206, or in accordance with any suitable method of storing such data.

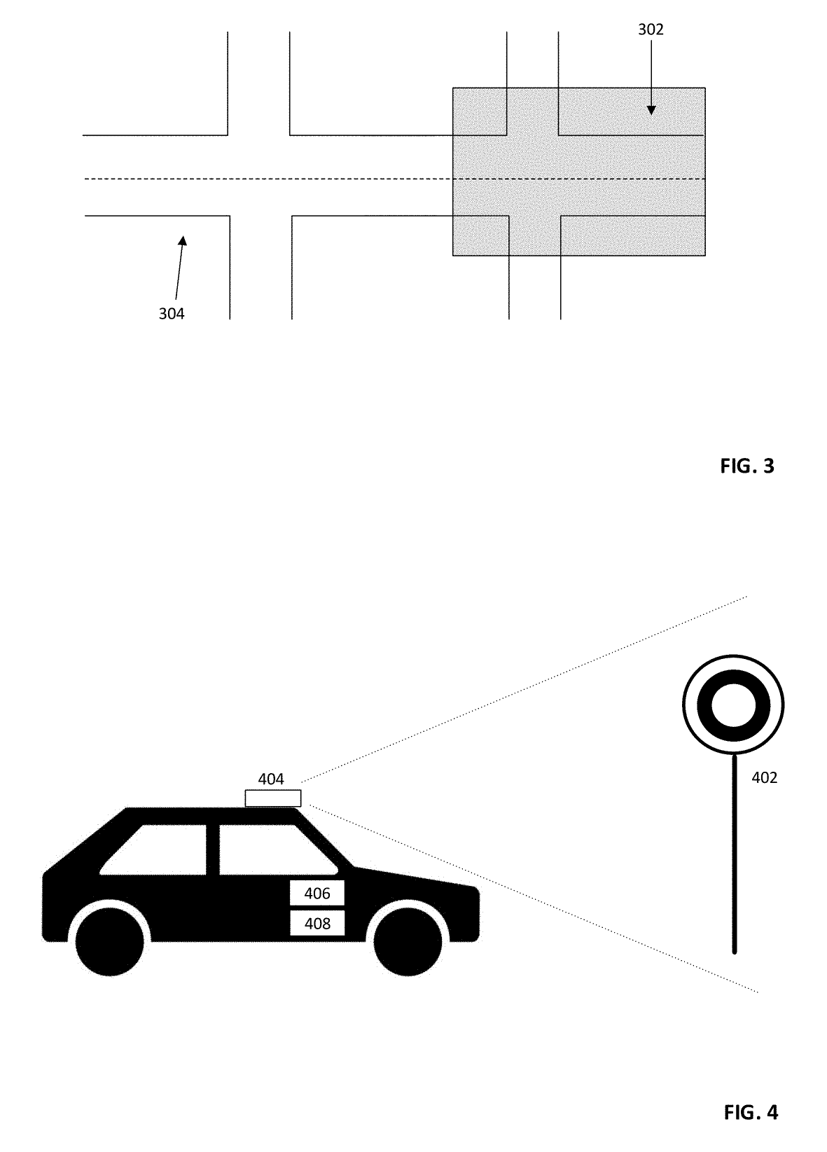

FIG. 3 shows a street configuration with a street-based emission restriction. With an aim of improving pollution, various cities have implemented or considered local implementations of emission restrictions in specific streets or neighborhoods. For example, in the city of Hamburg, Germany, an emission restriction prohibits certain diesel vehicles from operating along certain streets. FIG. 3 shows a hypothetical street configuration including street segments in which a given emission restriction applies 302 (shaded region, denoting a street segment with an emission restriction), and street segments in which the given emission restriction does not apply 304 (non-shaded sections). The street segments with the given emission restriction may be defined by corresponding location information, such that a vehicle with a determined location may compare its determined location with the corresponding location information to determine whether the vehicle is within a segment with an emission restriction. As disclosed, infra, these regions may also be designated by a sign. The areas corresponding to an emission restriction may be bounded by one or more streets, unbounded by streets, or otherwise applied to any desired region. For example, the emission region 302 is depicted as including both the street region for which it is intended (the shaded portion of the horizontal street) as well as portions of the adjacent, perpendicular street, and portions of the street-shoulders. The emission restriction area 304 could alternatively be limits to the roadway, or it could include multiple streets, one or more neighborhoods, one or more postal codes, or any other designation whatsoever, whether based on a roadway or otherwise.

FIG. 4 shows an emission restriction sensor recognition, according to an aspect of the disclosure. Where an emission restriction is implemented, a sign 402 may be installed to signify a location where the emission restriction is in effect. The sign 402 may be in written form, pictorial form, a symbol, or otherwise (the concentric circles of sign 402 presented herein are offered merely for example, and any shape or design, whether with or without text, would be possible). The vehicle may be equipped with one or more image sensors 404, which are configured to obtain image data from a vicinity of the vehicle and to transmit the corresponding image data to one or more processors 406. The one or more processors 406 are configured to detect within the image data the presence of a sign corresponding to an emission restriction. The emission restriction may be known to the vehicle, or readily available via download or otherwise, and based on the detected emission restriction, the vehicle may be configured to select an engine profile. Whether alternatively or in addition to visual recognition of a sign as detailed above, a marker for an emission restriction may comprise a transmitter, which is configured to transmit a signal. The vehicle may be configured to identify the present of an emission zone based on the received signal from the transmitter. The signal may comprise at least one of information indicating the presence of an emission restriction, a location of the emission restriction, one or more boundaries of an area of the emission restriction, a type of emission restriction or feature of the emission restriction, a vehicle emission requirement, or any combination thereof.

The vehicle may include a memory 408, on which is stored the data corresponding to images of one or more signs corresponding to an emission restriction. Upon receiving the image data, the one or more processors may be configured to compare the image data with the stored data corresponding to images of one or more signs, and on the basis of that comparison, detect within the image data the presence of image data corresponding to an emission restriction sign.

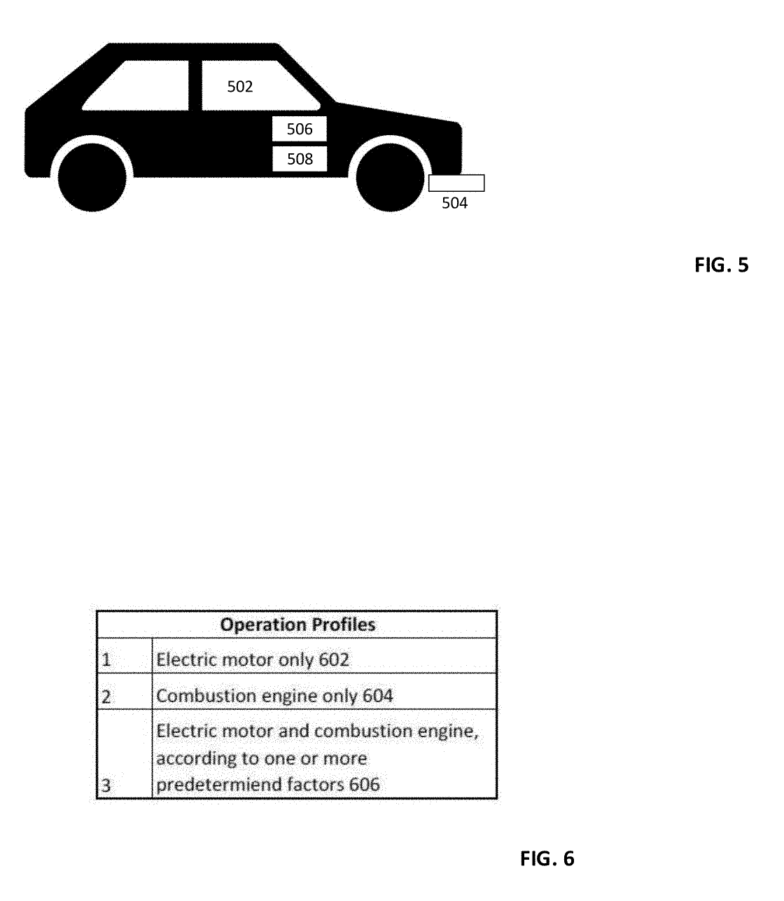

FIG. 5 shows a vehicle equipped with a sensor for environmental factor analysis. Rather than detecting a sign or other signifier of an emission restriction, the vehicle 502 may be equipped with a sensor 504 to perform a testing or analysis of an environmental factor, such an analysis of particulate matter concentration, carbon dioxide, nitrogen oxide, or other emission component. The sensor 504 may be configured to deliver its results to one or more processors 506, which are configured to select an engine profile based at least in part on the analysis results. The one or more processors may be programmed with one or more predetermined thresholds, such that a testing result above or below a corresponding threshold triggers a selection of a corresponding engine profile. For example, a low particulate matter engine profile may be selected due to a test result of particulate matter above a predetermined threshold. One or more results of the analysis may be stored in a memory 508

According to another aspect of the disclosure, the engine profile may be a profile for operation of a hybrid vehicle, which includes both an electric motor and a combustion motor. A hybrid vehicle may operate using exclusively an electric motor, exclusively a combustion engine, or using a combination of an electric motor and combustion engine (dual mode). When operating according to the dual mode, the vehicle may alternate between the electric motor and combustion engine based on one or more criteria, or the vehicle may operate with both the electric motor and combustion engine concurrently. FIG. 6 depicts three engine profiles for hybrid vehicles, as described herein. The first profile 602 permits exclusive operation of the electric motor; the second profile 604 permits exclusive operation of the combustion engine; and the third profile 606 permits operation of the electric motor and the combustion engine, according to one or more predetermined conditions.

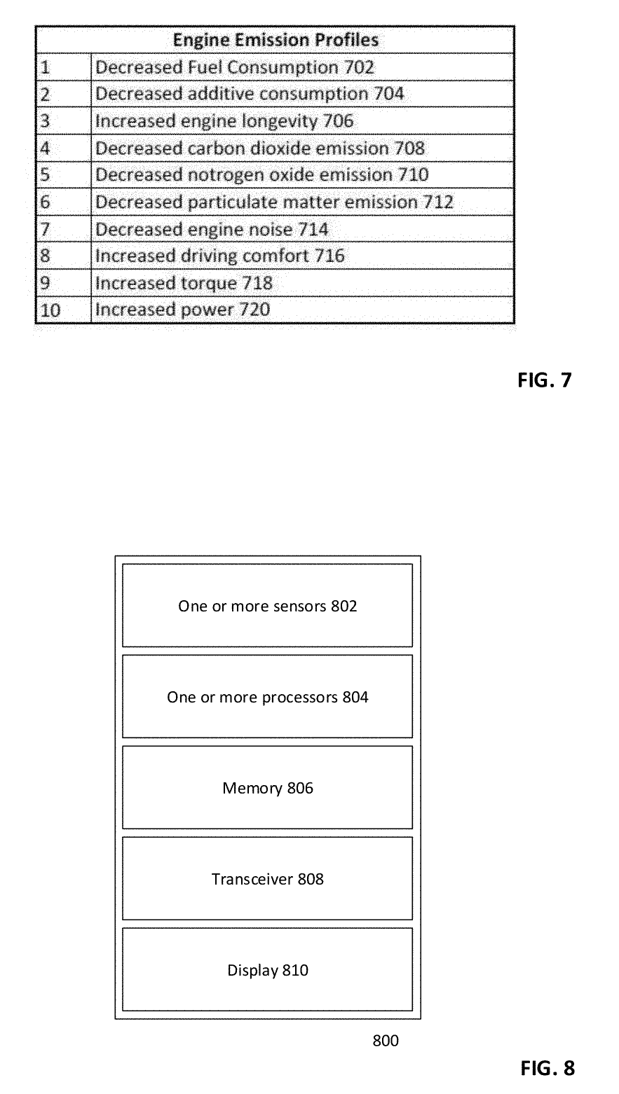

FIG. 7 shows a plurality of vehicle engine emission profiles. The vehicle may be configured to operate according to at least one of a plurality of vehicle engine emission profiles, to achieve a desired engine emission. Said profiles may be stored in a memory and available as desired during vehicle operation. Said profiles may be stored on a memory within the vehicle at manufacture, or the vehicle may be configured to periodically receive new or updated engine profiles. Said new or updated engine profiles may be transmitted to the vehicle wirelessly over a vehicle transceiver, such as in a vehicle to internet connection, or the profiles may be transmitted to the vehicle in a corded connection. Engine emission profiles may be quite varied, and a person skilled in the art of combustion engine software modification will understand the factors and methods of altering the performance of the combustion engine to achieve a desired emissions output. Such software profiles may include, but are not limited to, modification of fuel volume and injection timing, fuel ignition timing, sensor interpretation, air to field ratio, etc. According to one aspect of the disclosure, engine emission profiles may include decreased fuel consumption 702, decreased additive consumption (such as, for example, AdBlue for diesel engines) 704, increased engine longevity 706, decreased carbon dioxide emissions 708, decreased nitrogen oxide (NOx) emissions 710, decreased particulate matter emissions 712, decreased engine noise 714, increased driving comfort 716, increased torque 718, and increased power 720.

FIG. 8 shows a vehicle engine operation profile selection device 800 including one or more sensors 802, configured to detect sensor data; one or more processors 804, configured to select an engine operation profile from a plurality of engine operation profiles based on the sensor data; and operate an engine according to the selected engine operation profile. The vehicle engine operation profile selection device 800 may further include a memory 806 configured to store emission information in association with one or more locations, wherein the one or more processors are configured to selecting an engine operation profile by receiving the position sensor data, determining an emission information associated with the position in the memory, and selecting an engine operation profile that corresponds to the emission information; and/or a memory, configured to store geographic data associated with emission information; wherein the sensor is a position sensor, configured to determine a position of the vehicle; and wherein selecting an engine operation profile based on the sensor data comprises correlating from the stored geographic data the determined position of the vehicle with a corresponding emission information, and selecting an engine operation profile based on the corresponding emission information. The vehicle engine operation profile selection device 800 may further include a transceiver or receiver 808, configured to wirelessly receive at least one of geographic data, air quality data, or updated engine operation profile data. The vehicle engine operation profile selection device 800 may further include a display 810, configured to display the selected engine operation profile.

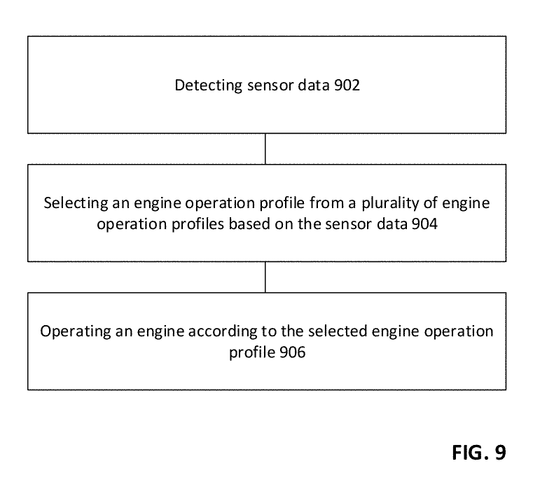

FIG. 9 shows a method of vehicle engine operation profile selection comprising detecting sensor data 902; selecting an engine operation profile from a plurality of engine operation profiles based on the sensor data 904; and operating an engine according to the selected engine operation profile 906.

The vehicle may be configured with a transceiver or receiver, which is configured to wirelessly receive the geographic information and environmental information. Many vehicles are currently equipped with a receiver or transceiver for wireless communication, such as vehicle-to-vehicle communication, vehicle-to-infrastructure communication, and vehicle to network communication. The vehicle may be configured to wirelessly connect with one or more sources to wirelessly receive the geographic information and/or wireless information.

According to one aspect of the disclosure, and engine profile may be selected according to the following: the vehicle's location may be derived from a position detector, such as a GPS receiver; data storage in the vehicle's control systems or navigation equipment may used to store maps with emission restricted zones (such as regions, cities, streets) and necessary metadata, wherein the map can be updated periodically via a mobile internet connection; data storage in the car's control system contains sets of engine management parameters, such as normal, reduced-CO2, reduced-NOx, reduced-particles. Optionally, these parameter sets or profiles can also be updated by the mobile internet connection. A mechanism/logic implemented in software may derive the correct engine management profile based on location and/or map data. The profile selected will be communicated to the driver and to the engine management. The driver awareness of a change in engine performance is achieved via an optical indicator (LED sign) or on a display (software defined cockpit, heads-up-display or in-vehicle infotainment), which may be beneficial in creating user acceptance of this method, displaying the advantage of mobility versus a small compromise in engine performance. The engine management may apply the profile selected previously and achieve the necessary emission profile. With the emissions matching the regulation of the car's location, the car is legally allowed to operate.

The use of location-based information to switch the engine type in hybrid cars between electric motors and combustion engines may satisfy environmental rules and regulations and may lead to a healthier environment in crowded areas and can circumvent unpleasant driving area restrictions. Both manually driven cars with such a system, as well as fully autonomous cars benefit.

According to one aspect of the disclosure, the engine profiles may be directed toward increasing or decreasing an engine input (such as fuel, additives, etc); increasing or decreasing an engine output (such as carbon dioxide, a nitrogen oxide, particulate matter, power, or torque); or operation of a hybrid vehicle (such as electric motor only, combustion engine only, and combination of or alternation between electric motor and combustion engine).

Regarding increasing or decreasing of an engine input, all engines require some form of engine input from which power is derived, whether it be gasoline, diesel, an electrical charge, hydrogen, or otherwise. Moreover, the operation of certain engines requires the addition of additives, such as diesel engines requiring the addition of AdBlue. It may be desirable to select an engine profile that decreases an engine input. Decreased engine input may be closely tied to cost, and therefore reduction of input may correspond to reduction of operating expense. Moreover, reduction of input may equate to reduction of pollutants or reduction of engine emission. As such the selection of an engine profile for reduction of engine input may equate to, or be closely correlated with, a reduction in engine emission. Moreover, in circumstances when engine emission is of less importance, such as in circumstances when a particular emission restriction is not in place, it may be desirable to select an engine profile for reduced engine input for its own merit.

Engine profiles may be selected for reduction of an engine output. As described herein, engine outputs may be regulated, such as for environmental or pollution reasons. Profiles may alter combustion engine factors, such as, for example, combustion timing, fuel input, fuel to air ratio, etc., so as to achieve a reduction in a specific output. Such output reductions may include, but are not limited to, reduced carbon dioxide, reduced nitrogen dioxide (NOx), and reduced particulate matter. Output reductions may also include reduced noise. Noise reduction may also correspond with an environmental restriction, as certain streets, neighborhoods, regions, etc. may regulate the noise output of a vehicle. Such areas may be referred to as “quiet zones”, and it may be desirable to employ a noise limiting engine profile to comply with “quiet zone” regulations.

The engine profile may include management of an electric motor, a combustion engine, or a combination of both in a hybrid vehicle. An electric motor may be considerably quieter than a combustion engine, which may be advantageous in situations when reduced noise is desired. Because an electric engine does not generally emit environmental pollutants, it may be desirable to operate according to an electric-only profile when operating in areas under certain environmental restrictions. For example, in areas of high nitrogen oxide or high particulate matter concentrations, a hybrid vehicle can be operated according to an electric motor only mode, and thereby reducing contribution of pollutants to the environment.

According to another aspect of the disclosure, a selection of one or more engine profiles may be triggered by a remote communication. The vehicle may be configured with a transceiver, configured to wirelessly connect to an outside source. The outside source may be an Internet provider, such as through a vehicle-to-infrastructure, vehicle-to-vehicle, Internet of things, or other wireless data connection, or the transceiver may be configured to receive a wireless signal from a base station, beacon, or other transmitting object. The wireless signal may communicate a requirement of one or more engine profiles to be used. For instance, the signal may be transmitted when a large amount of particulate matter in the air is detected, and the signal may be configured to cause one or more vehicles to switch into an engine emission profile to decrease particulate matter. This may be performed with any engine emission profile. The transmission to prompt selection of a specific engine emission profile may be a vehicle-specific transmission, or it may be a transmission to cause a plurality of vehicles to adopt a specific engine emission profile. The transmission may be designed to cause any vehicle receiving the transmission to adopt a specific profile. Thus, a city or state, for example, may be able to issue a transmission to cause all vehicles receiving the transmission to operate under, for instance, an electric motor only engine profile.

The profiles may not be limited to emissions in the sense of matter emitted from the vehicle, but rather may include any additional regulated quality emitted from the vehicle. According to one aspect of the disclosure, this may also include noise. Therefore, a reduced noise engine profile may be included within the plurality of engine profiles, such that a vehicle operating under the reduced noise profile may produce fewer decibels of noise than a vehicle not operating under the reduced noise profile. The use of such profiles may be particularly advantageous in quiet zones or residential neighborhoods, where noise may be a disturbing factor. Similar to the sign recognition techniques described herein, supra, the vehicle may be equipped with an image sensor, configured to receive an image of a sign within a vicinity of the vehicle, and detect within the corresponding image data, data associated with a quiet sign or other sign corresponding to a reduced noise engine profile. Based on detecting such a sign, the vehicle may employ the reduced noise profile as described herein.

The vehicle may be connected to an external data source, whether via a cable or a wireless connection, to update or modify the engine profiles. It is anticipated that the engine profiles may be periodically changed or improved, and therefore updating of such profiles may be desired. Moreover, as regulations change or new regulations are implemented, new engine profiles or modifications to existing profiles may be required. As such, it is contemplated that the vehicle may be able to update its existing profiles and/or receive additional profiles as need be.

According to one aspect of the disclosure, the vehicle engine operation profile selection device may include one or more sensors, which are configured to detect sensor data. The one or more sensors may be any kinds of sensors whatsoever, including, but not limited to, image sensors, transceivers, receivers, noise sensors, gas measuring sensors, particulate matter measuring sensors, or any combination thereof. The vehicle may be equipped with one or more processors, which are configured to select an engine operation profile from a plurality of engine operation profiles based at least on the sensor data. Once the engine operation profile is selected, the one or more processors may be configured to implement an engine operation profile.

The vehicle may include a location or position sensor, which is configured to determine a location or position of the vehicle. This may include any position determination technology whatsoever, whether a sensor configured to operate within the Global Positioning System network, a sensor configured to obtain a position based on one or more signals within a wireless communication network, or otherwise. The determine position may be compared to geographic information corresponding to one or more emission restrictions, in order to select an appropriate emission profile.

The vehicle may include a memory, which is configured to store an emission information associated with one or more locations. According to one aspect of the disclosure, the vehicle may be configured to receive geographic information that is cross-referenced with emission restrictions or preferred emission profiles, which may be stored in a memory. By obtaining a vehicle location, the determined location may be compared with the stored data, in order to select an appropriate emission profile.

In circumstances where the emission profile is selected based on sensor input, such as an air quality sensor, an image sensor, or a noise sensor, a location corresponding to the vehicle may be stored in the memory along with a selected emission profile. By storing this information, the vehicle may be configured to, when the vehicle reenters an area corresponding with a previously entered area in which a particular emission profile was used, select the previously used emission profile and implement said profile based on the stored memory data.

The vehicle may utilize one or more image sensors to select an engine emission profile. According to this aspect of the disclosure, the vehicle may utilize an image sensor, whether a still camera or video camera, a lidar sensor, an infrared sensor, or otherwise, to receive image data of a vicinity of the vehicle. The one or more processors may be configured to assess the image data and identify within said image data one or more signs or other indications of an emission restriction. Based on the identified indication of an emission restriction, the one or more processors may be configured to select a suitable emission profile and implement said profile within the vehicle.

According to another aspect of the disclosure, the engine profile may be selected based on a color of a traffic light. In this case, the one or more sensors may include one or more image sensors, which are configured to obtain image data associated with a vicinity of the vehicle where a traffic light is present. One or more processors then analyze the image data to identify a traffic light and to ascertain the color of the traffic light. An engine operation profile may be selected based on the color of the traffic light. For example, when a traffic light is red, it will be expected that a vehicle will either decelerate or be stationary. During this period, limited engine performance is necessary, if at all. As such, a vehicle engine profile may be selected based at least on the engine's ability to be operated at a decreased capacity. For example, a red or yellow traffic light may trigger an electric motor only profile for hybrid vehicles, or may trigger an engine profile such as a reduced gas emission profile, reduced noise emission profile, reduced particulate matter emission profile, or otherwise.

The vehicle may be equipped with one or more air quality sensors, which are configured to receive an air sample and analyze said air sample to determine one or more aspects of the corresponding air quality. Based on the results of the air quality analysis, the vehicle may be configured to select a corresponding emission profile. For example, where the surrounding air contains high levels of nitrogen oxide or carbon dioxide, a low nitrogen oxide or low carbon dioxide engine profile may be selected, respectively.

The vehicle may be equipped with one or more processors configured to perform a machine learning function with respect to the emission profiles. The machine learning function may be performed based at least on historical data, such as prior selected engine emission profiles, prior air quality analyses, prior emission restrictions corresponding to a location of the vehicle, prior vehicle locations, or otherwise. The machine learning function may employ one or more algorithms to select an engine emission profile using the prior data.

The vehicle may be equipped with one or more processors configured to calculate a vehicle route based on a missions information. Under some circumstances, and omissions restriction may prohibit a vehicle from entering an area, particularly when a suitable corresponding omissions profile is unavailable. Thus, where an omission restriction is detected, the vehicle may attempt to employ a suitable omissions profile, and in the event that a suitable omissions profile is unavailable, the vehicle may calculate an alternative route, thereby circumventing an area of the omissions restriction. Moreover the vehicle may be configured to detect one or more areas of emission restriction, and to plan a route to circumvent an area of emission restriction, even when a suitable omissions profile is available.

The vehicle may be configured to wirelessly receive any of geographic data, air quality data or updated engine operation profile data. The vehicle may be configured to connect with one or more services providing geographic information associated with air quality or omission restrictions. Such sources may be privately owned or public.

The vehicle may comprise a display, which is configured to indicate a selected engine profile. The display may be visible to a driver or passenger, such that the driver or passenger is apprised of the selected engine profile. The selected engine profile may be communicated wirelessly to an outside source, such as a base station, a database, a central hub, or otherwise.

According to another aspect of the disclosure, the vehicle engine profiles may include a smog mode, which may be a mode configured to eliminate one or more emission products that contribute to smog. The smog mode may be triggered based on a smog warning or smog report, as received by the vehicle. Various local and state bodies, as well as private companies, publish smog reports, based on measurements from an area or region. The smog reports may include a report on a severity of smog within a given region. The one or more processors may be configured to implement a smog mode during a period of high smog, or period of smog above a predetermined threshold. The one or more processors may be configured to discontinue using the smog mode when smog has decreased beneath a predetermined threshold.

According to another aspect of the disclosure, the one or more vehicle sensors may include an RFID reader, configured to obtain wirelessly transmitted information from one or more RFID chips or beacons. According to this configuration, information about a restriction may be included in an RFID chip, which may be placed in any vicinity in which vehicles may travel. Upon traveling within a vicinity of the RFID chip, the reader will be able to read the contents of the RFID chip and can take action accordingly by implementing an appropriate and corresponding emission profile.

According to another aspect of the disclosure, a response or responses to one or more emission restrictions may be selected based on factors of a plurality of vehicles rather than an individual vehicle. That is, an emission restriction may be applied to a plurality of vehicles based on a common affiliation rather than a geographic presence within a predetermined zone. The affiliation may be based on common ownership, a common property interest, a common use, a common purpose, or otherwise. For example, an emission restriction may be applied to a fleet of vehicles, such that the sum total of fleet emission is limited based on one or more emission or pollution standards. An engine profile may then be selected based on the group emission standards. The selection of an engine profile may consider any factor whatsoever including, but not limited to, prior emission output of any vehicles within the fleet and the requirements of a driver or passenger of one or more vehicles. For example, a fleet of five vehicles may be subject to a group emission restriction, such as a group limit on a pollutant. Although one or more engine profiles may be used to reduce emission of a relevant pollutant, the use of said one or more engine profiles may be associated with a disadvantageous factor, such as, for example, a reduction in vehicle acceleration. Under this circumstance, it may be undesirable for each vehicle to operate using such a profile. Rather, the profiles may be implemented based, for example, on user requirements. For example, in the fleet of five vehicles, it may be the case that four vehicles are carrying passengers who are generally on time, and no special modifications are necessary for their passengers to timely reach their destinations; however, one vehicle, for example, may be carrying a passenger who is under a time constraint. The engine profiles may be selected such that the four vehicles apply the pollution-limiting emission profile, whereas the one vehicle under a time restriction applies a less restrictive profile. By implementing this approach, the passenger under the time constraint may be afforded additional acceleration, which may not have been available under a more restrictive emission profile, thereby potentially allowing the passenger to more rapidly reach the passenger's destination. This may permit the feel to balance the needs of the passengers or drivers while generally maintaining fleet-wide emission limits.

Although the term “vehicle” is used throughout, the principles, corresponding devices, and procedures disclosed herein may be performed by any aspect or module within the vehicle including, but not limited to, a central processing unit, an engine profile selection unit, a combination of units, or otherwise. The elements and principles disclosed herein may be implemented as a device, a system, a vehicle, a method, a means, or a non-transient computer readable media.

The following examples pertain to various aspects of the Disclosure:

In Example 1, a vehicle engine operation profile selection device is disclosed, comprising one or more sensors, configured to detect sensor data; and one or more processors, configured to: select an engine operation profile from a plurality of engine operation profiles based on the sensor data; and operate an engine according to the selected engine operation profile.

In Example 2, the device of Example 1 is disclosed, wherein the sensor is a position sensor, configured to determine a position of the vehicle.

In Example 3, the device of Example 2 is disclosed, further comprising a memory, configured to store emission information in association with one or more locations is disclosed, wherein the one or more processors are configured to selecting an engine operation profile by receiving the position sensor data, determining an emission information associated with the position in the memory, and selecting an engine operation profile that corresponds to the emission information.

In Example 4, the device of Example 2 is disclosed, further comprising a memory, configured to store geographic data associated with emission information; wherein the sensor is a position sensor, configured to determine a position of the vehicle; and wherein selecting an engine operation profile based on the sensor data comprises correlating from the stored geographic data the determined position of the vehicle with a corresponding emission information, and selecting an engine operation profile based on the corresponding emission information.

In Example 5, the device of Example 1 is disclosed, wherein the sensor is an image sensor, and wherein the image sensor is configured to receive image data from a vicinity of the vehicle.

In Example 6, the device of Example 5 is disclosed, wherein the one or more processors are further configured to detect an emission information in the image sensor data and to select an engine operation profile based on the detected emission information.

In Example 7, the device of Example 6 is disclosed, wherein the one or more processors are configured to detect the emission information by identifying within the image sensor data one or more signs or markers that indicate an emission information.

In Example 8, the device of Example 6 or 7 is disclosed, wherein the one or more processors are configured to determine an emission information by identifying a traffic light or a traffic light color within the image sensor data, and by selecting an engine operation profile based on the traffic light or traffic light color.

In Example 9, the device of Example 1 is disclosed, wherein the sensor is a transceiver, configured to receive an instruction to implement an engine operation profile, and wherein the one or more processors are configured to select the engine operation profile by selecting the engine operation profile according to the instruction.

In Example 10, the device of Example 1 is disclosed, wherein the sensor is an air quality sensor, configured to measure air quality in a vicinity of the vehicle, and wherein the one or more processors are configured to select the engine operation profile by selecting the engine operation profile according to the measured air quality.

In Example 11, the device of Example 1 is disclosed, further comprising a memory, configured to store one or more previously implemented engine operation profiles with an additional data reference, the additional data reference comprising least one of a time corresponding to a vehicle operation according to the previously implemented engine operation profile; a duration corresponding to a vehicle operation according to the previously implemented engine operation profile; a location corresponding to the previously implemented emissions profile; or any combination thereof.

In Example 12, the device of Example 11 is disclosed, wherein the one or more processors are further configured to perform a machine learning function, the machine learning function comprising selecting an engine operation profile based on the stored one or more previously implemented emissions profiles and data reference.

In Example 13, the device of any one of Example 1 to 12 is disclosed, wherein the one or more processors are further configured to calculate a route based on one or more emission informations.

In Example 14, the device of Example 13 is disclosed, wherein the calculated route is selected to avoid at least one region corresponding to an emission information.

In Example 15, the device of any one of Examples 1 to 14 is disclosed, further comprising a memory, configured to store at least one of a plurality of engine operation profiles; geographic data associated with one or more emission information; position data; image sensor data; or any combination thereof.

In Example 16, the device of any one of Examples 1 to 15 is disclosed, further comprising a transceiver, configured to wirelessly receive at least one of geographic data, air quality data, or updated engine operation profile data.

In Example 17, the device of Example 16 is disclosed, further comprising the one or more processors being configured to select an engine operation profile based on at least one of geographic data, air quality data, or updated engine operation profile data.

In Example 18, the device of any one of Examples 1 to 17 is disclosed, wherein the engine operation profiles comprise at least one of normal, reduced carbon dioxide, reduced carbon monoxide, reduced nitrogen oxide, reduced unburned hydrocarbons, reduced particulate matter, or any combination thereof.

In Example 19, the device of any one of Examples 1 to 18 is disclosed, further comprising a display, configured to display the selected engine operation profile.

In Example 20, the device of any one of Examples 1 to 19 is disclosed, further comprising a transceiver, configured to wirelessly receive a compulsory engine operation profile and an instruction for the one or more processors to select the compulsory engine operation profile.

In Example 21, the device of any one of Examples 1 to 20 is disclosed, wherein the one or more processors are configured to select among a plurality of engine operation profiles comprising combustion engine operation, electric engine operation, and combination combustion engine/electric engine operation.

In Example 22, a vehicle is disclosed, comprising one or more sensors, configured to detect sensor data; and one or more processors, configured to select an engine operation profile from a plurality of engine operation profiles based on the sensor data; and operate an engine according to the selected engine operation profile.

In Example 23, the vehicle of Example 22 is disclosed, wherein the sensor is a position sensor, configured to determine a position of the vehicle.

In Example 24, the vehicle of Example 22 is disclosed, further comprising a memory, configured to store emission information in association with one or more locations is disclosed, wherein the one or more processors are configured to selecting an engine operation profile by receiving the position sensor data, determining an emission information associated with the position in the memory, and selecting an engine operation profile that corresponds to the emission information.

In Example 25, the vehicle of Example 22 is disclosed, further comprising a memory, configured to store geographic data associated with one or more emission information; wherein the sensor is a position sensor, configured to determine a position of the vehicle; and wherein selecting an engine operation profile based on the sensor data comprises correlating from the stored geographic data the determined position of the vehicle with a corresponding emission information, and selecting an engine operation profile based on the corresponding emission information.

In Example 26, the vehicle of Example 22 is disclosed, wherein the sensor is an image sensor, and wherein the image sensor is configured to receive image data from a vicinity of the vehicle.

In Example 27, the vehicle of Example 26 is disclosed, wherein the one or more processors are further configured to detect an emission information in the image sensor data and to select an engine operation profile based on the determined emission information.

In Example 28, the vehicle of Example 27 is disclosed, wherein the one or more processors are configured to determine the emission information based on the image sensor data by identifying within the image sensor data one or more signs or markers that indicate an emission information.

In Example 29, the vehicle of Example 28 is disclosed, wherein the one or more processors are configured to determine an emission information based on the image sensor data by identifying a traffic light or a traffic light color within the image sensor data, and by selecting an engine operation profile based on the traffic light or traffic light color.

In Example 30, the vehicle of Example 22 is disclosed, wherein the sensor is a transceiver, configured to receive an instruction to implement an engine operation profile, and wherein the one or more processors are configured to select the engine operation profile by selecting the engine operation profile according to the instruction.

In Example 31, the vehicle of Example 2 is disclosed, wherein the sensor is an air quality sensor, configured to measure air quality in a vicinity of the vehicle, and wherein the one or more processors are configured to select the engine operation profile by selecting the engine operation profile according to the measured air quality.

In Example 32, the vehicle of Example 2 is disclosed, further comprising a memory, configured to store one or more previously implemented engine operation profiles with an additional data reference, the additional data reference comprising least one of a time corresponding to a vehicle operation according to the previously implemented engine operation profile; a duration corresponding to a vehicle operation according to the previously implemented engine operation profile; a location corresponding to the previously implemented emissions profile; or any combination thereof.

In Example 33, the vehicle of Example 32 is disclosed, wherein the one or more processors are further configured to perform a machine learning function, the machine learning function comprising selecting an engine operation profile based on the stored one or more previously implemented emissions profiles and data reference.

In Example 34, the vehicle of any one of Example 22 to 33 is disclosed, wherein the one or more processors are further configured to calculate a route based on the emission information.

In Example 35, the vehicle of Example 34 is disclosed, wherein the calculated route is selected to avoid at least one region corresponding to an emission information.

In Example 36, the vehicle of any one of Examples 22 to 35 is disclosed, further comprising a memory, configured to store at least one of a plurality of engine operation profiles; geographic data associated with one or more emission information; position data; image sensor data; or any combination thereof.

In Example 37, the vehicle of any one of Examples 22 to 36 is disclosed, further comprising a transceiver, configured to wirelessly receive at least one of geographic data, air quality data, or updated engine operation profile data.

In Example 38, the vehicle of Example 37 is disclosed, further comprising the one or more processors being configured to select an engine operation profile based on at least one of geographic data, air quality data, or updated engine operation profile data.

In Example 39, the vehicle of any one of Examples 22 to 38 is disclosed, wherein the engine operation profiles comprise at least one of normal, reduced carbon dioxide, reduced carbon monoxide, reduced nitrogen oxide, reduced unburned hydrocarbons, reduced particulate matter, or any combination thereof.

In Example 40, the vehicle of any one of Examples 22 to 39 is disclosed, further comprising a display, configured to display the selected engine operation profile.

In Example 41, the vehicle of any one of Examples 22 to 40 is disclosed, further comprising a transceiver, configured to wirelessly receive a compulsory engine operation profile and an instruction for the one or more processors to select the compulsory engine operation profile.

In Example 42, the vehicle of any one of Examples 22 to 41 is disclosed, wherein the one or more processors are configured to select among a plurality of engine operation profiles comprising combustion engine operation, electric engine operation, and combination combustion engine/electric engine operation.

In Example 43, a method of vehicle engine operation profile selection is disclosed comprising detecting sensor data; selecting an engine operation profile from a plurality of engine operation profiles based on the sensor data; and operating an engine according to the selected engine operation profile.

In Example 44, the method of Example 43 is disclosed, wherein the sensor information is position information of a position of the vehicle.

In Example 45, the method of Example 44 is disclosed, further comprising storing emission information in association with one or more locations; selecting an engine operation profile by receiving the position information; determining an emission information associated with the position information; and selecting an engine operation profile that corresponds to the emission information.

In Example 46, the method of Example 43 is disclosed, further comprising storing geographic data associated with emission information; determining a position of the vehicle; and wherein selecting an engine operation profile comprises correlating from the stored geographic data the determined position of the vehicle with a corresponding emission information, and selecting an engine operation profile based on the corresponding emission information.

In Example 47, the method of Example 43 is disclosed, further comprising receiving image data from a vicinity of the vehicle.

In Example 48, the method of Example 47 is disclosed, further comprising detecting an emission information in the image data and to select an engine operation profile based on the determined emission information.

In Example 49, the method of Example 48 is disclosed, wherein the one or more processors are configured to determine the emission information based on the image sensor data by identifying within the image data one or more signs or markers that indicate an emission information.

In Example 50, the method of Example 49 is disclosed, further comprising determining an emission information based on the image data by identifying a traffic light or a traffic light color within the image sensor data, and by selecting an engine operation profile based on the traffic light or traffic light color.

In Example 51, the method of Example 43 is disclosed, wherein the sensor data is wirelessly received data comprising an instruction to implement an engine operation profile is disclosed, further comprising selecting the engine operation profile according to the instruction.

In Example 52, the method of Example 43 is disclosed, wherein the sensor data is air quality data associated with an air quality in a vicinity of the vehicle, and further comprising selecting the engine operation profile according to the measured air quality.

In Example 53, the method of Example 43 is disclosed, further comprising storing one or more previously implemented engine operation profiles with an additional data reference, the additional data reference comprising at least one of a time corresponding to a vehicle operation according to the previously implemented engine operation profile; a duration corresponding to a vehicle operation according to the previously implemented engine operation profile; a location corresponding to the previously implemented emissions profile; or any combination thereof.

In Example 54, the method of Example 53 is disclosed, further comprising performing a machine learning function, the machine learning function comprising selecting an engine operation profile based on the stored one or more previously implemented emissions profiles and data reference.

In Example 55, the method of any one of Example 43 to 54 is disclosed, further comprising calculating a route based on one or more emission information.

In Example 56, the method of Example 55 is disclosed, further comprising selecting the route to avoid at least one region corresponding to an emission information.

In Example 57, the method of any one of Examples 43 to 57 is disclosed, further comprising storing in a memory at least one of a plurality of engine operation profiles; geographic data associated with one or more emission information; position data; image sensor data; or any combination thereof.

In Example 58, the method of any one of Examples 43 to 57 is disclosed, further comprising wirelessly receiving at least one of geographic data, air quality data, or updated engine operation profile data.

In Example 59, the method of Example 58 is disclosed, further comprising further comprising selecting an engine operation profile based on at least one of geographic data, air quality data, or updated engine operation profile data.

In Example 60, the method of any one of Examples 43 to 59 is disclosed, wherein the engine operation profiles comprise at least one of normal, reduced carbon dioxide, reduced carbon monoxide, reduced nitrogen oxide, reduced unburned hydrocarbons, reduced particulate matter, or any combination thereof.

In Example 61, the method of any one of Examples 43 to 60 is disclosed, further comprising displaying the selected engine operation profile.

In Example 62, the method of any one of Examples 43 to 60, wirelessly receiving a compulsory engine operation profile and an instruction for the one or more processors to select the compulsory engine operation profile.

In Example 63, the method of any one of Examples 43 to 62 is disclosed, further comprising selecting among a plurality of engine operation profiles comprising combustion engine operation, electric engine operation, and combination combustion engine/electric engine operation.

In Example 64, the device of any one of Examples 1 to 21 is disclosed, wherein the engine profiles are profiles to regulate a first engine type and a second engine type, and wherein the engine of the first type and the engine of the second type use different types of fuel.

In Examine 65, the device of Examine 64, wherein one of the first type or the second type is either a combustion engine or an electric motor, and wherein neither of the second type is a combustion engine or an electric motor.

In Example 64, a means for vehicle engine operation profile selection is disclosed, comprising one or more sensing means, configured to detect sensor data; and one or more processing means, configured to: select an engine operation profile from a plurality of engine operation profiles based on the sensor data; and operate an engine according to the selected engine operation profile.

In Example 65, the means of Example 64 is disclosed, wherein the sensing means is a position sensor, configured to determine a position of the vehicle.

In Example 66, the means of Example 65 is disclosed, further comprising a storage means, configured to store emission information in association with one or more locations is disclosed, wherein the one or more processing means are configured to selecting an engine operation profile by receiving the position sensor data, determining an emission information associated with the position in the memory, and selecting an engine operation profile that corresponds to the emission information.

In Example 67, a non-transient computer readable medium is disclosed, configured to perform the method of any one of Examples 43 to 63.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. A vehicle engine operation profile selection device comprising
one or more sensors, configured to detect sensor data; and
one or more processors, configured to:
select an engine operation profile from a plurality of engine operation profiles based on the sensor data; and
operate an engine according to the selected engine operation profile.

2. The device of claim 1, wherein the sensor is a position sensor, configured to determine a position of the vehicle.

3. The device of claim 2, further comprising a memory, configured to store emission information in association with one or more locations, wherein the one or more processors are configured to selecting an engine operation profile by receiving the position sensor data, determining an emission information associated with the position in the memory, and selecting an engine operation profile that corresponds to the emission information.

4. The device of claim 2, further comprising a memory, configured to store geographic data associated with emission information;
wherein the sensor is a position sensor, configured to determine a position of the vehicle; and
wherein selecting an engine operation profile based on the sensor data comprises correlating from the stored geographic data the determined position of the vehicle with a corresponding emission information, and selecting an engine operation profile based on the corresponding emission information.

5. The device of claim 1, wherein the sensor is an image sensor, and wherein the image sensor is configured to receive image data from a vicinity of the vehicle.

6. The device of claim 5, wherein the one or more processors are further configured to detect an emission information in the image sensor data and to select an engine operation profile based on the detected emission information.

7. The device of claim 6, wherein the one or more processors are configured to detect the emission information by identifying within the image sensor data one or more signs or markers that indicate an emission information.

8. The device of claim 6, wherein the one or more processors are configured to determine an emission information by identifying a traffic light or a traffic light color within the image sensor data, and by selecting an engine operation profile based on the traffic light or traffic light color.

9. The device of claim 1, wherein the sensor is a transceiver, configured to receive an instruction to implement an engine operation profile, and wherein the one or more processors are configured to select the engine operation profile by selecting the engine operation profile according to the instruction.

10. The device of claim 1, wherein the sensor is an air quality sensor, configured to measure air quality in a vicinity of the vehicle, and wherein the one or more processors are configured to select the engine operation profile by selecting the engine operation profile according to the measured air quality.

11. The device of claim 1, further comprising a memory, configured to store one or more previously implemented engine operation profiles with an additional data reference, the additional data reference comprising least one of a time corresponding to a vehicle operation according to the previously implemented engine operation profile; a duration corresponding to a vehicle operation according to the previously implemented engine operation profile; a location corresponding to the previously implemented emissions profile; or any combination thereof, wherein the one or more processors are further configured to perform a machine learning function, the machine learning function comprising selecting an engine operation profile based on the stored one or more previously implemented emissions profiles and data reference.

12. The device of claim 1, further comprising a memory, configured to store at least one of a plurality of engine operation profiles; geographic data associated with emission information; position data; image sensor data; or any combination thereof.

13. The device of claim 1, further comprising a transceiver, configured to wirelessly receive at least one of geographic data, air quality data, or updated engine operation profile data, further comprising the one or more processors being configured to select an engine operation profile based on at least one of geographic data, air quality data, or updated engine operation profile data.

14. The device of claim 1, wherein the engine operation profiles comprise at least one of normal, reduced carbon dioxide, reduced carbon monoxide, reduced nitrogen oxide, reduced unburned hydrocarbons, reduced particulate matter, or any combination thereof.

15. The device of claim 1, wherein the one or more processors are configured to select among a plurality of engine operation profiles comprising combustion engine operation, electric engine operation, and combination combustion engine/electric engine operation.

16. A vehicle comprising
one or more sensors, configured to detect sensor data; and
one or more processors, configured to:
select an engine operation profile from a plurality of engine operation profiles based on the sensor data; and
operate an engine according to the selected engine operation profile.

17. The vehicle of claim 16, wherein the sensor is a position sensor, configured to determine a position of the vehicle.

18. The vehicle of claim 16, wherein the sensor is an image sensor, and wherein the image sensor is configured to receive image data from a vicinity of the vehicle, and wherein the one or more processors are further configured to detect an emission information in the image sensor data and to select an engine operation profile based on the determined emission information.

19. A method of vehicle engine operation profile selection comprising
detecting sensor data;
selecting an engine operation profile from a plurality of engine operation profiles based on the sensor data; and
operating an engine according to the selected engine operation profile.

20. The method of claim 19, wherein the sensor information is position information of a position of the vehicle, further comprising storing emission information in association with one or more locations; selecting an engine operation profile by receiving the position information; determining an emission information associated with the position information; and selecting an engine operation profile that corresponds to the emission information.
